(19) United States
(12) Patent Application Publication
(10) Pub. No.: US 2009/0287710 A1
(43) Pub. Date: Nov. 19, 2009

(54) PORTABLE STORAGE MEDIA, HOST DEVICE AND METHOD OF ACCESSING THE CONTENT OF THE PORTABLE STORAGE MEDIA BY THE HOST DEVICE

(75) Inventors: Rob Van Den Boome, Valkenswaard (NL); Igor Paulussen, Nuenen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,420

(22) PCT Filed: May 30, 2006
(86) PCT No.: PCT/IB06/51715

§ 371 Date: Nov. 26, 2007

(30) Foreign Application Priority Data
May 31, 2005 (EP) 05104692.8

(51) Int. Cl. G06F 17/30

(52) U.S. Cl. 707/10; 707/100; 707/E17.01

(57) ABSTRACT

The invention relates to a portable storage media (1) comprising resources and metadata wherein the portable storage media (1) further comprises a representation file representing the resources, the metadata and their interrelationships. The invention further relates to a Host device (2) that is designed to cooperate with at least one portable storage media (1), which portable storage media (1) comprises resources and metadata wherein the portable storage media (1) further comprises a representation file representing the resources, the metadata and their interrelationships, and wherein the host device (2) comprises evaluating means that are designed for evaluating the representation file to provide a Content Directory Service of the stored resources.

### FIELD OF THE INVENTION

The invention relates to a portable storage media comprising a representation file.

The invention further relates to a host device that is designed to corporate with the portable storage media according to the first paragraph.

The invention further relates to a method of accessing the content of the portable storage media according to first paragraph by the host device according to the second paragraph.

### BACKGROUND OF THE INVENTION

The home environment is going to significant changes with respect to audio, video (AV), PC equipment and (digital) content handling. The PC world and the consumer electronic world (CE-world) are integrating and form larger and larger home networks shaping the so called connected home. Via these networks, content from the PC, digital still cameras, camcorders, the Internet and television broadcast channels all become available in the living room.

Consequently, this development has let to a vast amount of data which still increases and requires some form of content management, which is offered via various metadata standards. An example for those metadata standards is MPEG 21, UPnP, MPV, HighMAT etc. From these standards, given the present market direction and standardization activities, it could be assumed that home networks will be based on the UPnP standard in the future. To display the content of portable storage media like USB-sticks, CD-ROMs, DVDs etc., the CE-PC-systems to which those portable storage media are removable connected need to scan the whole media to gather the metadata of the individual files. For different content types, different metadata standards are used. MPV and HighMAT are two metadata standards both very focussed on optical disk like CD-ROM or DVD, that try to solve this problem of metadata retrieval for removable storage media. However, MPV and HighMAT have no mechanism to expose metadata to other devices in a connected home network.

In UPnP networks, the UPnP Content Directory Service (UPnP CDS) standardizes metadata for music, photo and video data files. Via the UPnP CDS, the content is made available for the rest of the network. However, also in the UPnP standard no specific (separate) mechanism is defined to support portable storage media. That means that when a new portable storage media is detected, most of the UPnP Media Server implementations will have to scan the whole portable storage media file system to retrieve metadata of the storage content. This scanning process will be repeated everytime a portable storage media is connected to the system.

Therefore, in all present metadata standards, there is a need for fast metadata retrieval for portable storage media, which are removable connected to network devices to make the content available within a home network.

### OBJECT AND SUMMARY OF THE INVENTION

It is therefore an object of the invention to provide a portable storage media as defined in the first paragraph and a host device as defined in the second paragraph, as well as a method for accessing as defined in the third paragraph, in which the disadvantages defined above are avoided.

In order to achieve the object defined above with a portable storage media according to the invention characteristic features are provided so that a system according to the invention is characterized defined below that is:

Portable storage media comprising resources and metadata wherein the portable storage media further comprises a representation file representing the resources, the metadata and their interrelationships.

In order to achieve the object defined above with a host device according to the invention characteristic features are provided so that a host device according to the invention can be characterized in the way defined below that is:

Host device that is designed to cooperate with at least one portable storage media, which portable storage media comprises resources and metadata wherein the portable storage media further comprises a representation file representing the resources, the metadata and their interrelationships, and wherein the host device comprises evaluating means that are designed for evaluating the representation file to provide a Content Directory Service of the stored resources.

In order to achieve the object defined above with a method of accessing the content of a portable storage media by a host device according to the invention characteristic features are provided so that a method of accessing according to the invention can be characterized in the way defined below that is:

Method of accessing the content of portable storage media according to claim 1 by a host device according to claim 2 or 3 comprising the following steps:

connecting at least one portable storage media to the host device; upon detecting of the at least one portable storage media, evaluating the representation file of the at least one portable storage media and startup a Content Directory Service based on the evaluated representation file; providing access to said Content Directory Service of the at least one portable storage media.

The characteristic features according to the invention provide the advantage that a portable storage media, a host device and a method for accessing the content of the portable storage media by the host device are capable of fast metadata retrieval increasing their ability to be integrated in home networks of PC world and the CE world.

The measures as claimed in claim 3 and 5 provide the advantage that the portable storage media can be used with a host device capable of UPnP without any intermediate translation to populate UPnP Media Server which can expose its metadata local to the host device or to any other UPnP device in the home network.

The aspects defined above and further aspects of the invention are apparent from the example of embodiment to be described herein after and are explained with reference to the examples to the embodiment. The invention will be described in more detail herein after with reference to the examples of the embodiment that to which the invention is not limited.

### BRIEF DESCRIPTION OF THE DRAWINGS

FIG. 1 shows a basic concept of the invention in form of a schematic illustration.

FIG. 2 shows the basic concept of the invention according to a specific embodiment of the invention in form of a schematic illustration.

### DESCRIPTION OF EMBODIMENTS

To solve the above identified problem of fast metadata retrieval for portable storage media removable connected to a host device, the portable storage media further comprises a representation file describing all content items of the portable storage media. The portable storage media comprises resources, such as videos, audio tracks, images, etc., and metadata, such as descriptors, identifiers, etc.. Furthermore, the portable storage media further comprises a representation file representing all content items on a portable storage medium within one single file, that representation file storing UPnP CDS compliant metadata. The portable storage media is, for example, an optical disc or an USB-memory-stick which can be removable connected to a host device for retrieving the metadata stored on it. The representation file provides an hierarchical structure of metadata elements describing the content and provides a reference to the actual location of the content on the portable storage media. In a home network, the content location on the portable storage media is mapped onto the IP address of the host device. In one specific embodiment, the representation file is a XML document wherein the metadata are described in the DIDL-lite format. The DIDL-lite format is in turn specified within the UPnP CDS standard. If this XML-document is used as representation file, a CDS compatible (hierarchical) object-tree is defined and can be evaluated to display the content of the portable storage media.

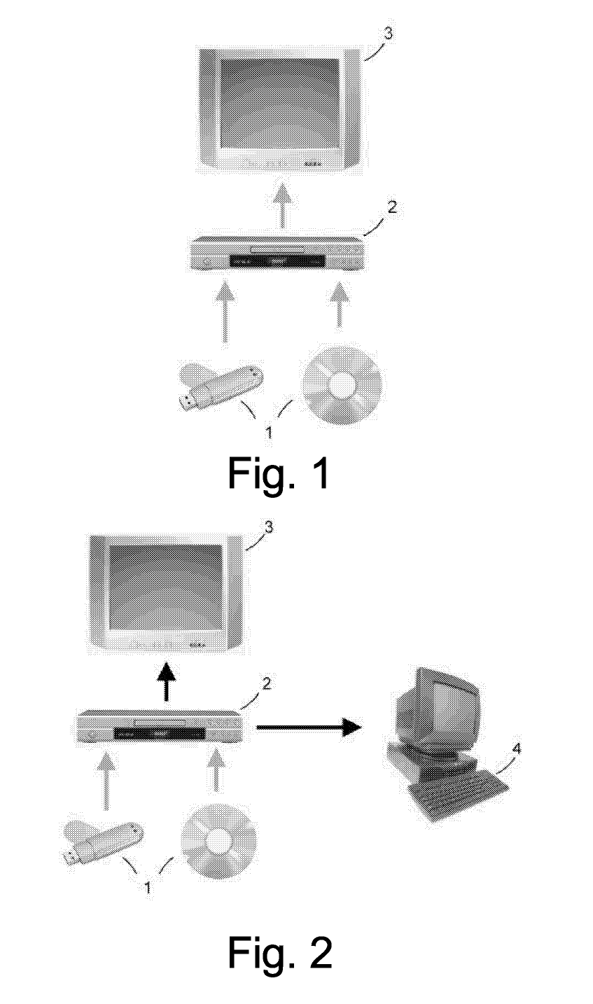

FIG. 1 shows a basic concept of the invention for a simple host device which is not UPnP (network) enabled. If a portable storage media 1 such as a USB-memory-stick or a CD/DVD is connected to the host device 2, a driver of the host device 2 uses the DIDL-lite XML-document to retrieve its metadata. Instead of scanning all media files stored on the portable storage media 1, the driver only needs to parse one XML-document to retrieve all metadata of all content items on the portable storage media 1. Compared to scanning the file system of the portable storage media 1, this substantially speeds up the process of retrieving the metadata to provide the content of the portable storage media 1 to a home network. The Content Directory Service can be displayed on a display device 3 such as an LCD-monitor of a notebook or on an TV connected to the host device 2. To retrieve the metadata of the portable storage media 1 connected to the host device 2, the host device 2 includes a parser for DIDL-lite XML-documents.

FIG. 2 shows another embodiment of the invention which comprises an advanced host device which is UPnP (network) enabled. In this particular case, the UPnP Media Server software as defined for the UPnP/AV-stack is embedded into the driver of the removable storage media 1 running on the host device 2 such as an PC or DVD-Player.

In this embodiment the driver starts a separate UPnP Media Server process for every portable storage media 1 that has be removable connected to the host device 2 and has been detected by the host device 2. Each UPnP Media Server process can be accessed by a control point of a UPnP device and can initiate and control data transfer to any UPnP Media Renderer connected to the network. The protocol for the data transfer of the UPnP network is TCP/IP so that UPnP network can also encompass internet links to remote UPnP Media Renderer, for example a notebook in the Office.

A method of accessing the content of portable storage media starts with the connecting of at least one portable storage media 1 to the host device 2. Upon detecting of the at least one portable storage media 1, the driver starts evaluating the representation file of the at least one portable storage media 1 by passing the representation file being in this case a DIDL-lite XML-document. Upon evaluating, the driver starts up a Content Directory Service based on the evaluated representation file representing a hierarchical structure of metadata stored on the portable storage media 1. Finally, access to that Content Directory Service of the at least one portable storage media 1 is provided by, for example, transferring this Content Directory Service to a display device 3 such as a LCD-display or TV-monitor.

In the embodiment of FIG. 2 where the host device 2 is UPnP network enabled, a Media Server for providing a UPnP Content Directory Service for each evaluated portable storage media 1 based on the evaluated representation file is initiated. On start-up the UPnP Media Server is populated with the metadata objects described in the DIDL-lite XML document. This enables the host device and other UPnP devices in the home network to quickly retrieve all the metadata of all content items stored in the portable storage media removable connected to the host device 2. Furthermore, the benefit of this additional method step is that the Media Server can expose its metadata local to the host device 2 or to any other UPnP device 4 in the home network.

However, according to an embodiment of the invention as described with reference to FIG. 1, also simple host devices 2 benefit from the provision of one single representation file describing all metadata of all content item on the portable storage media which ensures fast metadata retrieval.

It has to be noted that the representation does not necessarily has to be in DIDL-Lite XML format but somehow must include the interrelationships between the resources and metadata of the portable storage media in order to reflect a hierarchical structure of resources. Preferably, the representation file is designed to be processed by a parser such as a browser or the like.

It has to be appreciated that the reference signs within the claims are only given for illustrative purpose and shall not be construed as limiting the scope of the invention for which protection is sought after.

1-5. (canceled)

6. Portable storage media (1) comprising resources and metadata wherein the portable storage media (1) further comprises a representation file representing the resources, the metadata and their interrelationships characterized in that the representation file of the portable storage media is provided in compliance with a Content Directory Service standard for making the resources available in a home network.

7. Host device (2) that is designed to cooperate with at least one portable storage media (1), which portable storage media (1) comprises resources and metadata wherein
the portable storage media (1) further comprises a representation file representing the resources, the metadata and their interrelationships characterized in that
the representation file of the portable storage media is provided in compliance with a Content Directory Service standard for making the resources available in a home network; and
the host device (2) comprises evaluating means that are designed for evaluating the representation file of the portable storage media, according to the Content Directory Service standard, to provide a Content Directory Service of the stored resources.

8. A host device (2) according to claim 7, wherein
the host device (2) is designed to be connected to an Universal Plug and Play (UPnP) network,
the evaluating means are further designed for initiating a separate Media Server for each portable storage media (1) connected with the host device (2) and comprising an evaluable representation file,
and each Media Server is designed for providing based on the evaluable representation file a UPnP Content Directory Service being accessible by at least one UPnP Media Renderer via the UPnP network.

9. Host device according to claim 7 wherein the metadata and the interrelationships in the representation file are provided according to the Content Directory Service standard.

10. Host device according to claim 8 wherein the Content Directory Service standard is the UPnP Content Directory Service standard.

11. Host device according to claim 7 wherein the evaluating means is a parser for DIDL-lite XML documents.

12. Method of accessing the content of portable storage media (1) comprising resources and metadata wherein the portable storage media (1) further comprises a representation file representing the resources, the metadata and their interrelationships characterized in that the representation file of the portable storage media is provided in compliance with a Content Directory Service standard for making the resources available in a home network by a host device (2) according to claim 7 comprising the following steps:
connecting at least one portable storage media (1) to the host device (2);
upon detecting of the at least one portable storage media (1),
evaluating, according to the Content Directory Service standard, the representation file of the at least one portable storage media (1) and startup a Content Directory Service based on the evaluated representation file;
providing access to said Content Directory Service of the at least one portable storage media (1).

13. Method of accessing the content of portable storage media (1) comprising resources and metadata wherein the portable storage media (1) further comprises a representation file representing the resources, the metadata and their interrelationships characterized in that the representation file of the portable storage media is provided in compliance with a Content Directory Service standard for making the resources available in a home network by a host device (2) according to claim 8 comprising the following steps:
connecting at least one portable storage media (1) to the host device (2);
upon detecting of the at least one portable storage media (1),
evaluating, according to the Content Directory Service standard, the representation file of the at least one portable storage media (1);
initiating a Media Server for providing based on the evaluated representation file a UPnP Content Directory Service for each evaluated portable storage media (1);
providing access to said Content Directory Service of the at least one portable storage media (1).

14. Method of writing a representation file on a portable storage media (1) comprising resources and metadata wherein the representation file representing the resources, the metadata and their interrelationships characterized in that the representation file of the portable storage media is provided in compliance with a Content Directory Service standard for making the resources available in a home network.
